(19) United States
(12) Patent Application Publication
(10) Pub. No.: US 2018/0130426 A1
(43) Pub. Date: May 10, 2018

(54) DISPLAY DEVICE

(71) Applicant: Wuhan China Star Optoelectronics Technology Co., Ltd., Wuhan (CN)

(72) Inventors: Zhenzhou XING, Wuhan (CN); Bin XIONG, Wuhan (CN); Yao Li HUANG, Wuhan (CN)

(73) Assignee: Wuhan China Star Optoelectronics Technology Co., Ltd., Wuhan (CN)

(21) Appl. No.: 14/897,679

(22) PCT Filed: Jul. 29, 2015
(86) PCT No.: PCT/CN2015/085376

§ 371 Date: Jun. 30, 2017

(30) Foreign Application Priority Data
May 19, 2015 (CN) 201510255868.0

(51) Int. Cl. G09G 3/34; G09G 3/36

(52) U.S. Cl. CPC G09G 3/3406; G09G 2320/0233; G09G 2310/0264; G09G 3/3611

(57) ABSTRACT

Disclosed is a display device which belongs to the technical field of display, and is able to solve the technical problem of unequal resistances of leads in a fan-out conducting wire, thus reducing effects on display uniformity of a display panel.

### CROSS-REFERENCE TO RELATED APPLICATIONS

The present application claims the priority of Chinese patent application CN201510255868.0, entitled “Display device” and filed on May 19, 2015, the entirety of which is incorporated herein by reference.

### TECHNICAL FIELD

The present disclosure relates to the technical field of display, and in particular, to a display device.

TECHNICAL BACKGROUND

With the development of display technology, liquid crystal display devices have become the most common display devices.

In a liquid crystal display device, images are displayed through control of pixels by criss-cross gate lines and data lines on a substrate. Gate drive signal and source drive signal are sent out from a chip of a drive circuit of the liquid crystal display device, and are transmitted respectively to gate lines and data lines on the substrate by means of a chip on film (COF).

Specifically, as shown in FIG. 1, a COF is connected to a gate line or a data line of a display panel by a fan-out conducting wire which comprises a plurality of leads 1. Because the fan-out conducting wire is in a fan shape as a whole, the leads 1 located on both sides of the fan-out conducting wire each have a length larger than the leads 1 in the middle of the fan-out conducting wire, and consequently have a resistance larger than the leads 1 in the middle, which can cause the waveform of the gate drive signal or the source drive signal transmitted by the leads 1 on the both sides to be seriously distorted, thereby affecting the uniformity of the gate drive signal or the source drive signal, and further affecting display uniformity of the display panel.

### SUMMARY OF THE INVENTION

The objective of the present disclosure is to provide a display device, so as to solve the technical problem of unequal resistances of leads in a fan-out conducting wire, whereby effects on display uniformity of display panels can be avoided.

The embodiments of the present disclosure provide a display device. The display device comprises a display panel and a drive circuit disposed on the periphery of the display panel. The drive circuit comprises a plurality of output ends arranged side by side. The display panel is provided thereon with a plurality of input ends arranged side by side and corresponding to the output ends of the drive circuit. Each of the output ends of the drive circuit and each of the corresponding input ends of the display panel are provided therebetween with a same resistance. Or, a drive signal output from each of the output ends of the drive circuit is enhanced from middle to both sides accordingly.

Each of the output ends of the drive circuit and each of the input ends of the display panel are connected to each other with a fan-out conducting wire which includes a plurality of leads. The length of the plurality of leads increases gradually from middle to both sides of the fan-out conducting wire.

The plurality of leads has a same resistance.

Each of the plurality of leads is provided thereon with a through hole. The number of the through holes on the leads decreases gradually from middle to both sides of the fan-out conducting wire, so that the plurality of leads can have a same resistance.

The through holes have a same size.

Each of the plurality of leads is provided thereon with a resistor. The resistance of each of the resistors decreases gradually from middle to both sides of the fan-out conducting wire, so that the plurality of leads can have a same resistance.

A width of each of the plurality of leads increases gradually from middle to both sides of the fan-out conducting wire, so that the plurality of leads can have a same resistance.

The output ends of the drive circuit each are provided with a resistor connected serially thereto. The resistance of each of the resistors decreases gradually from middle to both sides of the output ends arranged side by side.

The display device further comprises a linear operational amplifier module disposed on a side of the drive circuit close to the display panel, for accessing the drive signal output by each of the output ends of the drive circuit. Degree of amplifying the drive signal output by each of the output ends by the linear operational amplifier module increases gradually from middle to both sides of the output ends arranged side by side.

The degree of amplifying the drive signal output by each of the output ends by the linear operational amplifier module increases linearly from middle to both sides of the output ends arranged side by side.

The present disclosure achieves the following beneficial effects. The present disclosure provides a display device which comprises a display panel and a drive circuit disposed on the periphery of the display panel. According to the display device, each of the output ends of the drive circuit and each of the corresponding input ends of the display panel are provided therebetween with a same resistance, or, the drive signal can be enhanced properly based on attenuation degree thereof after the drive signal passes through the fan-out conducting wire, whereby the display uniformity of the display panel can be improved.

Other features and advantages of the present disclosure will be further explained in the following description, and will partly become self-evident therefrom, or be understood through the implementation of the present disclosure. The objectives and advantages of the present disclosure will be achieved through the structures specifically pointed out m the description, claims, and the accompanying drawings.

### BRIEF DESCRIPTION OF THE DRAWINGS

For further illustrating the technical solutions provided in the embodiments of the present disclosure, a brief introduction will be given below to the accompanying drawings involved in the embodiments.

FIG. 1 schematically shows the structure of a display device according to the existing technologies;

FIG. 2 schematically shows the structure of a fan-out conducting wire according to embodiment 1 of the present disclosure;

FIG. 3 schematically shows the structure of a display device according to embodiment 2 of the present disclosure;

FIG. 4 schematically shows the structure of a display device according to embodiment 3 of the present disclosure;

FIG. 5 schematically shows the relationship between resistance and length of a lead according to embodiments 2 and 3 of the present disclosure;

FIG. 6 schematically shows the structure of a display device according to embodiment 4 of the present disclosure;

FIG. 7 schematically shows the structure of a display device according to embodiment 5 of the present disclosure; and

FIG. 8 schematically shows the relationship between operational amplification degree and length of a lead according to embodiment 5 of the present disclosure.

### DETAILED DESCRIPTION OF THE EMBODIMENTS

The present disclosure will be explained in detail below with reference to the embodiments and the accompanying drawings, so that one can fully understand how the present disclosure solves the technical problem and achieves the technical effects through the technical means, thereby implementing the same. It should be noted that as long as there is no structural conflict, any of the embodiments and any of the technical features thereof may be combined with one another, and the technical solutions obtained therefrom all fall within the scope of the present disclosure.

The present disclosure provides a display device which comprises a display panel, and a drive circuit disposed on the periphery of the display panel. The drive circuit, comprises a plurality of output ends arranged side by side, and the display panel is provided thereon with a plurality of input ends arranged side by side and corresponding to the output ends of the drive circuit. Each of the output ends of the drive circuit and each of the corresponding input ends of the display panel are provided therebetween with a same resistance.

It should be noted that, since the embodiment of the present disclose will not involve a gate drive signal output by a gate drive circuit or a source drive signal output by a source drive circuit, the gate drive circuit and the source drive circuit will not be differentiated from each other in description and will be generally referred to as drive circuit. Similarly, the gate drive signal output by the gate drive circuit or the source drive signal output by the source drive circuit will be generally referred to as drive signal.

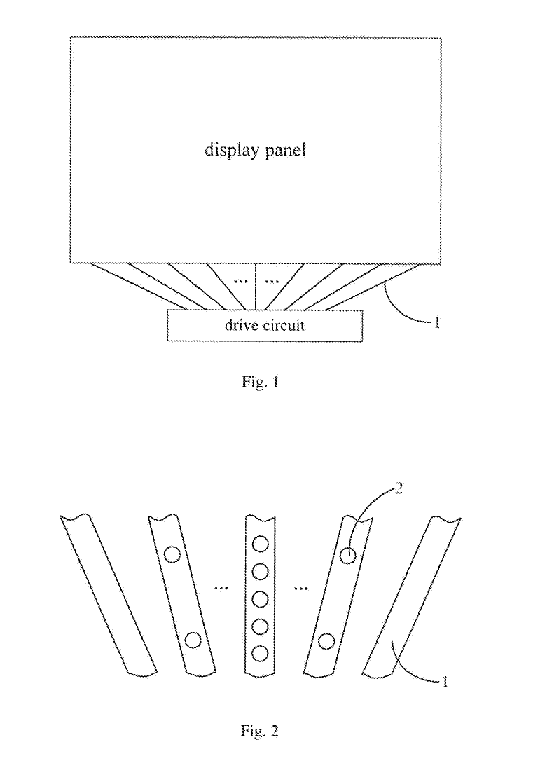

As shown in FIG. 1, the drive circuit has a plurality of output ends, and accordingly, the display panel has a same number of input ends. The drive circuit is integrated on a printed circuit board (PCB) which is far smaller than the display panel in size. The output ends of the drive circuit and the corresponding input ends of the display panel are usually connected to each other with a fan-out conducting wire which comprises of a plurality of leads 1. Because the fan-out conducting wire is in a fan shape as a whole, the leads 1 on both sides of the fan-out conducting wire each have a length larger than the leads 1 in the middle of the fan-out conducting wire. With width and material of each of the leads 1 being the same, it can be known, based on the formula for resistance

$$R = ρ \frac{l}{S}$$

(where ρ is the resistivity of lead 1, l is the length of the lead 1, and S is the cross-sectional area of the lead 1), that the leads 1 on both sides of the fan-out conducting wire each have a resistance larger than the leads 1 in the middle of the fan-out conducting wire, which can result in serious attenuation and delay of the drive signal transmitted by the leads 1 on both sides of the fan-out conducting wire, thus leading to serious distortion of said drive signal transmitted by the leads 1 on both sides, affecting uniformity of said drive signal, and further affecting display uniformity of the display panel.

Therefore, in order to improve uniformity of the drive signal and display uniformity of the display panel, in the present disclosure, the resistance of each of the leads 1 is adjusted or compensated in advance, which can be achieved by the following methods.

It can be known from the above that the resistance of the lead 1 is determined by its cross-sectional area and length, and that in the existing technologies, the leads 1 in the fan-out conducting wire have a same cross-sectional area. However, as shown in FIG. 1, the leads each have a different length, and therefore, with the material of each of the leads being the same, the leads each will have a different resistance. As shown in FIG. 2, in embodiment 1 of the present disclosure, a through hole 2 can be provided on each of the leads 1 to adjust the resistance of each of the leads 1 and enable the resistances of the leads 1 to be the same.

Specifically, provided that each of the through holes has a same size, for each of the leads 1 in the fan-out conducting wire, the number of the through holes decreases gradually from middle to both sides of the fan-out conducting wire. The arc of the through hole 2 can extend the length of the lead 1 and further increase the resistance of the lead 1. The through hole 2 can be provided on a part of the lead which is disposed on the display panel, or can be provided on a part of the lead which is disposed on a chip on film (COF), since the drive circuit and the display panel are connected to each other through the COF. Both methods can enable the leads 1 to have a same resistance, thus improving display uniformity.

Obviously, only the leads 1 other than the two leads 1 located on both sides of the fan-out conducting wire are provided thereon with an appropriate number of the through holes, so that the leads 1 other than said two leads on both sides and the leads on both sides can have a same resistance.

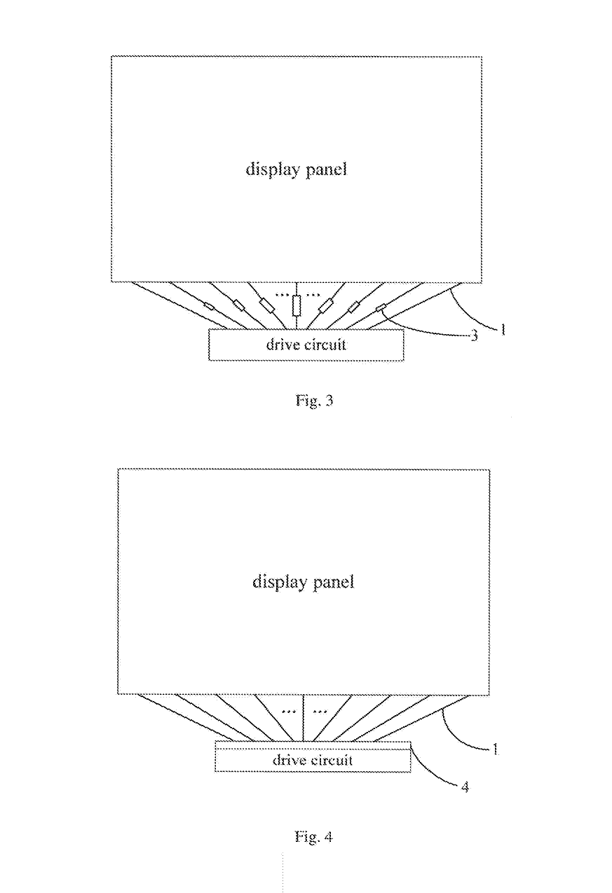

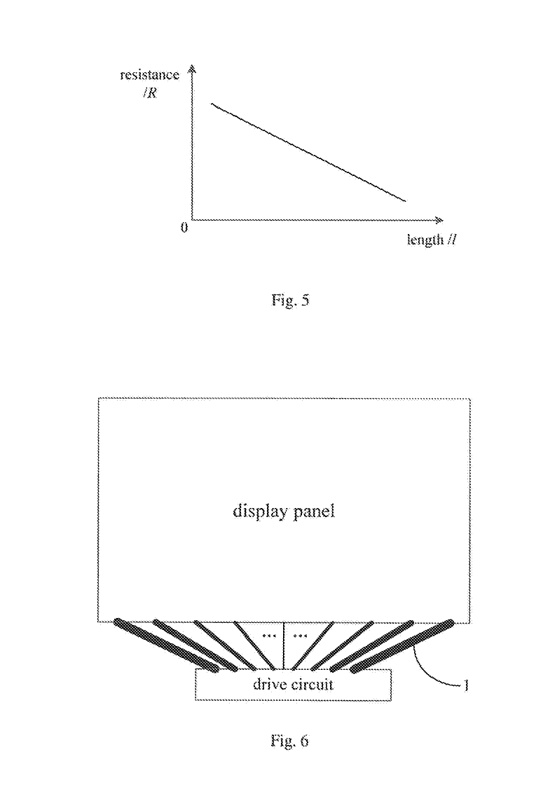

As shown in FIG. 3, in embodiment 2 of the present disclosure, the leads 1 each have a same width. In order to enable the leads 1 each have a same resistance, the leads 1 each can be provided thereon with a resistor 3 having a suitable resistance connected serially thereto. Specifically, as shown in FIG. 5, the resistance of each of the resistors for compensating the resistance of each of the leads 1 decreases linearly with the increase of the length of the leads 1. That is, the resistance of each of the resistors 3 connected serially to each of the leads 1 decreases gradually from middle to both sides of the fan-out conducting wire. In other words, the closer a lead 1 is to the middle of the fan-out conducting wire, the larger the resistance of the resistor 3 connected thereto is, and the closer a lead 1 is to both sides of the fan-out conducting wire, the smaller the resistance of the resistor 3 connected thereto is. It should be noted that the two leads 1 located on both sides of the fan-out conducting wire may not be provided with the resistor 3 connected serially thereto. By providing the serially connected resistor 3, the leads 1 other than said two leads on both sides can have the same resistance as the leads on both sides, whereby the display uniformity of the display panel can be improved.

In addition, the resistor 3, instead of being connected serially to each of the leads 1, can be integrated in advance in an integrated circuit (IC) provided with a driving circuit. Specifically, as shown in FIG. 4, in embodiment 3 of the present disclosure, a parallel resistor string 4 is provided at the output ends of the drive circuit. As shown in FIG. 5, the resistance of each of the resistors in the resistor string 4 also exhibits a linear change by decreasing linearly from middle to both sides of the fan-out conducting wire. That is, the longer a lead 1 is, the smaller the resistance of a corresponding resistor in the resistor string 4 is. In other words, for each of the output ends of the drive circuit, the resistance of each of the resistors connected serially thereto decreases gradually from middle to both sides of the fan-out conducting wire. By providing the linear resistor string 4 integrated in the IC, the resistance of each of the leads 1 having a different length is balanced, whereby the display uniformity of the display panel can be improved.

It can be known from the formula of resistance

$$R = ρ \frac{l}{S}$$

that the resistance is inversely proportional to the cross-sectional area of the lead 1. Therefore, if the height of the lead 1 cannot be increased, the present height of the lead 1 can be kept, while the width of the lead 1 can be increased to reduce the resistance of the lead 1. Specifically, as shown in FIG. 6, in embodiment 4 of the present disclosure, the width of each of the leads 1 is increased from middle to both ends of the fan-out conducting wire. That is, the width of the lead 1 in the very middle of the fan-out conducting wire is kept unchanged, while the width of other leads is increased gradually as these leads get farther from the lead 1 in the very middle. In this case, the lead 1 in the middle and other leads 1 will have a same resistance. A ratio of the width of a lead to the width of the lead 1 in the very middle of the fan-out conducting wire is equal to a ratio of the length of said lead 1 to the length of the lead 1 in the very middle. By increasing the width of each of the leads 1, increment of resistance of each of the leads due to the longer length can be offset, and the leads 1 are caused to have a same resistance.

Obviously, the above methods all aim at improving the display uniformity of the display panel by changing or compensating the resistance of the leads 1.

As shown in FIG. 1, the leads 1 in the fan-out conducing wires are the same in material and width, and are different only in length. The longer a lead 1 is, the larger the resistance of said lead 1 is, and the more serious and distinct the attenuation of a drive signal transmitted by said lead 1 is.

In order to improve the display uniformity of the display panel, the attenuation of the drive signal can also be compensated by enabling the drive signal output by each of the output ends of the drive circuit to be enhanced from middle to both ends of the fan-out conducting wire. The drive signal output should be amplified to such a degree that the attenuation of the drive signal caused by the leads having different lengths could be offset, thus enabling the drive signal actually received by the corresponding input ends of the display panel to be basically the same as that should be received theoretically.

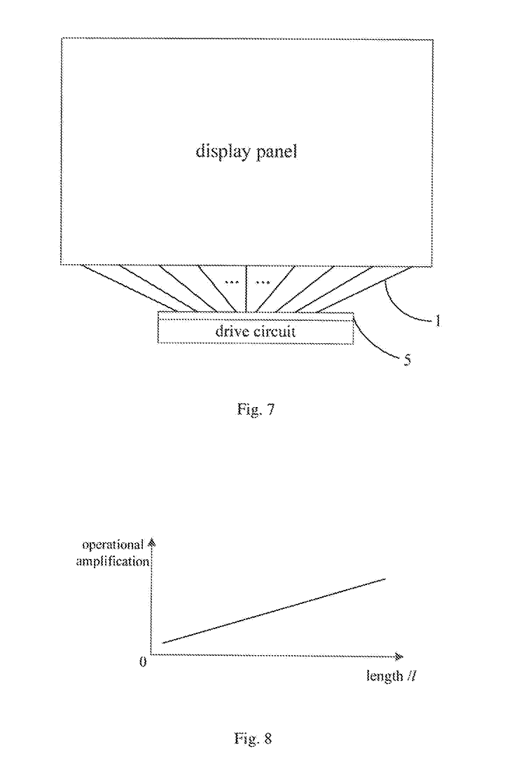

Specifically, in embodiment 5 of the present disclosure, as shown in FIG. 7, the IC having the drive circuit is provided with a linear operational amplifier module 5 on a side of the drive circuit close to the display panel. An input end of the linear operational amplifier module 5 is connected to the output end of the drive circuit, for accessing, the drive signal output by the drive circuit, and amplifying and compensating the drive signal. The amplified and compensated drive signal is then transmitted to input ends of the leads in the fan-out conducting wire through an output end of the linear operational amplifier module 5, and then transmitted to the display panel by the fan-out conducting wire so as to be displayed by the display panel.

Since the length of the leads 1 in the fan-out conducting wire increases gradually from middle to both ends, degree of amplifying the drive signal output by the output ends by the linear operational amplifier module 5 increases gradually from middle to both sides of the output ends of the drive circuit arranged side by side. Specifically, as shown in FIG. 8, the amplification degree, by the linear operational amplifier module 5, of the drive signal output by the output end of the drive circuit increases linearly with the increase of the length of said lead 1 which transmits said drive signal. By providing the linear operational amplifier module 5, the resistance of each of the leads 1 having a different length, as well as the attenuation degree of the drive signal is balanced, whereby the display uniformity of the display panel can be improved.

In conclusion, the embodiments of the present disclosure provide a display device which comprises a display panel, and a drive circuit disposed on the periphery of the display panel. In the display device, each of the output ends of the drive circuit and each of the corresponding input ends of the display panel are provided therebetween with a same resistance, or, the drive signal can be enhanced properly based on the attenuation degree thereof after the drive signal passes through the fan-out conducting wire, whereby the display uniformity of the display panel can be improved.

The above embodiments are described only for better understanding, rather than restricting the present disclosure. Anyone skilled in the art can make amendments to the implementing forms or details without departing from the spirit and scope of the present disclosure. The scope o the present disclosure should still be subject to the scope defined in the claims.

1. A display device, comprising a display panel and a drive circuit disposed on the periphery of the display panel, the drive circuit comprising a plurality of output ends arranged side by side, and the display panel being provided thereon with a plurality of input ends arranged side by side and corresponding to the output ends of the drive circuit,
wherein each of the output ends of the drive circuit and the corresponding input end of the display panel are provided therebetween with a same resistance, or
a drive signal output by each of the output ends of the drive circuit is enhanced gradually from middle to both sides.

2. The display device according to claim 1, wherein each of the output ends of the drive circuit and each of the input ends of the display panel are connected to each other through a fan-out conducting wire which includes a plurality of leads, a length of the plurality of leads increasing gradually from middle to both sides of the fan-out conducting wire.

3. The display device according to claim 2, wherein the plurality of leads has a same resistance.

4. The display device according to claim 3, wherein each of the plurality of leads is provided thereon with a through hole the number of the through holes decreasing gradually from middle to both sides of the fan-out conducting wire, so that the plurality of leads can have a same resistance.

5. The display device according to claim 4, wherein the through holes have a same size.

6. The display device according to claim 3, wherein each of the plurality of leads is provided thereon with a resistor, a resistance of each of the resistors decreasing gradually from middle to both sides of the fan-out conducting wire, so that the plurality of leads can have a same resistance.

7. The display device according to claim 3, wherein a width of each of the plurality of leads increases gradually from middle to both sides of the fan-out conducting wire, so that the plurality of leads can have a same resistance.

8. The display device according to claim 2, wherein each of the output ends of the drive circuit is provided with a resistor connected serially thereto, a resistance of each of the resistors decreasing gradually from middle to both sides of the output ends arranged side by side.

9. The display device according to claim 2, further comprising a linear operational amplifier module disposed on a side of the drive circuit close to the display panel, for accessing the drive signal output by each of the output ends of the drive circuit, degree of amplifying the drive signal output by each of the output ends by the linear operational amplifier module increasing gradually from middle to both sides of the output ends arranged side by side.

10. The display device according to claim 9, wherein the degree of amplifying the drive signal output by each of the output ends by the linear operational amplifier module increases linearly from middle to both sides of the output ends arranged side by side.
